(19) United States
(12) Patent Application Publication
(10) Pub. No.: US 2017/0103073 A1
(43) Pub. Date: Apr. 13, 2017

(54) Identifying Expert Reviewers

(71) Applicant: Quixey, Inc., Mountain View, CA (US)

(72) Inventor: Jonathan Ben-Tzur, Sunnyvale, CA (US)

(73) Assignee: Quixey, Inc., Mountain View, CA (US)

(21) Appl. No.: 14/878,796

(22) Filed: Oct. 8, 2015

(51) Int. Cl. G06F 17/30

(52) U.S. Cl. CPC G06F 17/3053; G06F 17/30554; G06F 17/3056; G06F 17/30601

(57) ABSTRACT

A method includes receiving review data of objects and generating user profiles. Each user profile is associated with a user and includes review records. Each review record is associated with review data for an object. The method includes associating an entity with each review record and determining a mapping between the objects, the user profiles, and the entities. Each object is mapped to at least one entity, and each entity is mapped to at least one user profile based on the review records of the at least one user profile and whether any of the review records is associated with the corresponding entity. The method includes identifying for each entity, users having user profiles mapped to the entity and having a threshold number of review records associated with the corresponding entity as expert users. The method includes receiving a search query from a user device and sending search results.

### TECHNICAL FIELD

This disclosure relates to identifying reviewers as expert reviewers based on a reviewing history.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications, games, educational applications, news applications, shopping applications, messaging applications, media streaming applications, social networking applications, and so much more. Furthermore, application developers develop vast amounts of applications within each genre and each application may have numerous editions.

Several of these diverse applications allow users to provide reviews relating to a product, an experience, a food, or any other item. Due to the large number of users providing reviews, it may be difficult to determine what reviews are more helpful than others. This may become burdensome and overwhelming for users trying to read and sort through these reviews.

### SUMMARY

One aspect of the disclosure provides a method for identifying expert reviewers. The method includes receiving, at data processing hardware, review data of objects from one or more data sources and generating, by the data processing hardware, user profiles based on the review data. Each user profile is associated with a user and includes one or more review records. Each review record is associated with review data for an object. The method further includes associating, by the data processing hardware, an entity with each review record and determining, at the data processing hardware, a mapping between the objects, the user profiles, and the entities. Each object is mapped to at least one entity, and each entity is mapped to at least one user profile based on the review records of the at least one user profile and whether any of the review records is associated with the corresponding entity. The method further includes identifying, at the data processing hardware, for each entity, users having user profiles mapped to the entity and having a threshold number of review records associated with the corresponding entity as expert users and receiving, at the data processing hardware, a search query from a user device in communication with the data processing hardware. The search query identifies a search object. The method also includes sending, from the data processing hardware to the user device, results that include: the review records from the user profiles of the expert users mapped to the search object; and an access mechanism for each review record. Each access mechanism has a reference to a corresponding application executable on the user device and indicates a performable operation for the corresponding application to enter an operating state providing information from the corresponding review record.

Implementations of the disclosure may include one or more of the following optional features. In some implementations, the object includes a physical item, an entity, a place, or an experience. The entity may include at least one of a business type, an object type, a cuisine, a location, or a food type. Each review record may include at least one of a review name, an application or a website associated with the review, text string, a rating, helpfulness information, or skill level information.

In some implementations, the method includes, after receiving the search query, identifying a corresponding entity associated with the search object; and determining, by the data processing hardware, one or more expert users mapped to the corresponding entity. Each profile record may include a user name or identifier, a geo-location associated with the user device, and the review records associated with corresponding entities.

Another aspect of the disclosure provides a second method for identifying expert reviewers. The method includes receiving, at data processing hardware of a user device, a search query via a graphical user interface of the user device in communication with the data processing hardware, the search query identifying a search object and sending the search query from the data processing hardware to a remote processing system. The method further includes receiving, at the data processing hardware from the remote processing system, results including review records from user profiles of expert users mapped to the search object. The user profiles are based on review data received at the remote processing system. Each user profile is associated with a user and includes one or more review records. Each review record is associated with review data associated with the search object and an entity. The user profiles of the expert users include users having user profiles mapped to the entity associated with the search object and having a threshold number of review records associated with the corresponding entity. The method further includes an access mechanism for each review record, each access mechanism having a reference to a corresponding application executable on the data processing hardware and indicating a performable operation for the corresponding application to enter an operating state providing information from the corresponding review record. The method further includes displaying, by the data processing hardware, one or more of the results on the graphical user interface.

This aspect may include one or more of the following optional features. The object may include a physical item, an entity, a place, or an experience. The entity includes at least one of a business type, an object type, a cuisine, a location, or a food type. Each review record may include at least one of a review name, an application or a website associated with the review, text string, a rating, helpfulness information, or skill level information. Each profile record may include a user name or identifier, a geo-location associated with the user device, and the review records associated with corresponding entities.

Yet another aspect of the disclosure provides a user device for identifying expert reviewers. The user device includes data processing hardware, a screen in communication with the data processing hardware, and memory hardware in communication with the data processing hardware. The memory hardware stores instructions that when executed on the data processing hardware cause the data processing hardware to perform operations. Those operations include receiving a search query via a graphical user interface displayed on a graphical user interface on the screen. The search query identifies a search object. The operations further include sending the search query from the data processing hardware to a remote processing system and receiving, at the data processing hardware from the remote processing system, results. Those results include review records from user profiles of expert users mapped to the search object. The user profiles are based on review data received at the remote processing system. Each user profile is associated with a user and includes one or more review records. Each review record is associated with review data associated with the search object and an entity. The user profiles of the expert users include users having user profiles mapped to the entity associated with the search object and having a threshold number of review records associated with the corresponding entity. The device further includes an access mechanism for each review record, each access mechanism having a reference to a corresponding application executable on the data processing hardware and indicating a performable operation for the corresponding application to enter an operating state providing information from the corresponding review record. The device also includes displaying one or more of the results on the graphical user interface.

This aspect may include one or more of the following optional features. The search object may include a physical item, an entity, a place, or an experience. The entity may include at least one of a business type, an object type, a cuisine, a location, or a food type. Each review record may include at least one of a review name, an application or a website associated with the review, text string, a rating, helpfulness information, or skill level information. Each profile record may include a user name or identifier, a geo-location associated with the user device, and the review records associated with corresponding entities.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an example environment including a user device in communication with a state rendering system and an expertise system.

FIG. 1B is a functional block diagram of an example system having a state rendering system and an expertise system that interact with the user device and data sources.

FIG. 2 is a schematic view of an example system having a state rendering system and an expertise system that interacts with the user device and provides search results to the user device.

FIG. 3 is a schematic view of an example search system.

FIG. 4 is a schematic view of an example state rendering system.

FIG. 5A is a schematic view of an example expertise system.

FIGS. 5B and 5C are schematic views of an example linking of the entities, user profiles, and reviews.

FIGS. 6A and 6B are schematic views of example application state records.

FIGS. 7A and 7B are schematic views of example entity records.

FIG. 8 is a schematic view of an example user profile record.

FIG. 9 is a schematic view of an example user device.

FIG. 10A is an example arrangement of operations for a method of identifying expert reviewers.

FIG. 10B is an example arrangement of operations for a method of identifying expert reviewers.

FIG. 11 is a schematic view of an example computing device executing any systems or methods described herein.

Like reference symbols in the various drawings indicate like elements.

### DETAILED DESCRIPTION

The present disclosure describes a system for identifying expert reviewers among a collection of reviewers. When a user reads a number of reviews of a product or service, the user may question which review is useful and/or become overwhelmed by a large number of conflicting reviews. It is desirable to provide a system that filters reviews and organizes the reviews based on an expertise level of the corresponding reviewers to offer the user with a useful and enjoyable experience.

A system includes a search system that can execute a search based on a query received from a user device. The user device receives the query inputted via a graphical user interface (GUI) of the user device, and in turn, sends the query to the search system. The search system executes a search and outputs search results (e.g., access mechanisms to access applications associated with reviews) based on the query. A state rendering system receives the search results from the search system and, for each search result, determines an entity (e.g., an object type) associated with the search result. For each entity associated with the search result, the state rendering system determines one or more experts who have previously provided reviews relating to the entity. The state rendering system provides the user device with the search results, associates expert reviews with each search result, and orders the expert reviews based on an expertise level of the expert. An expertise system may crawl data sources, such as webpages, for review data and processes the review data. In addition, the expertise system generates user profiles and links each user profile with one or more entities to determine the level of expertise of the user associated with each profile. The system enhances a user experience by determining which reviews relate to an entity and which reviewers may be more useful to the user based on the associated expertise level.

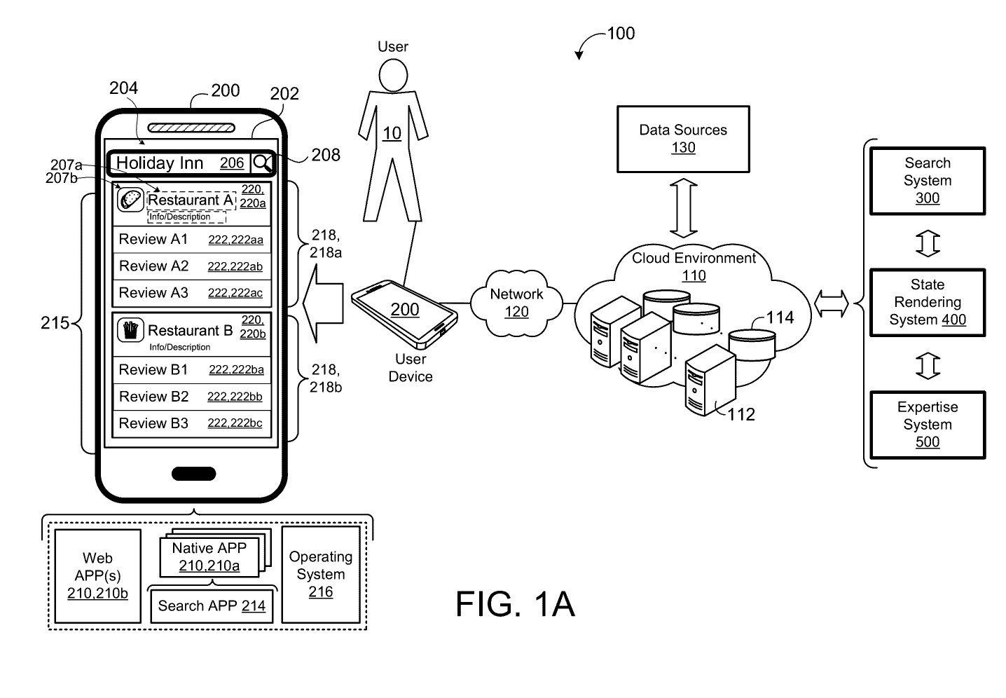

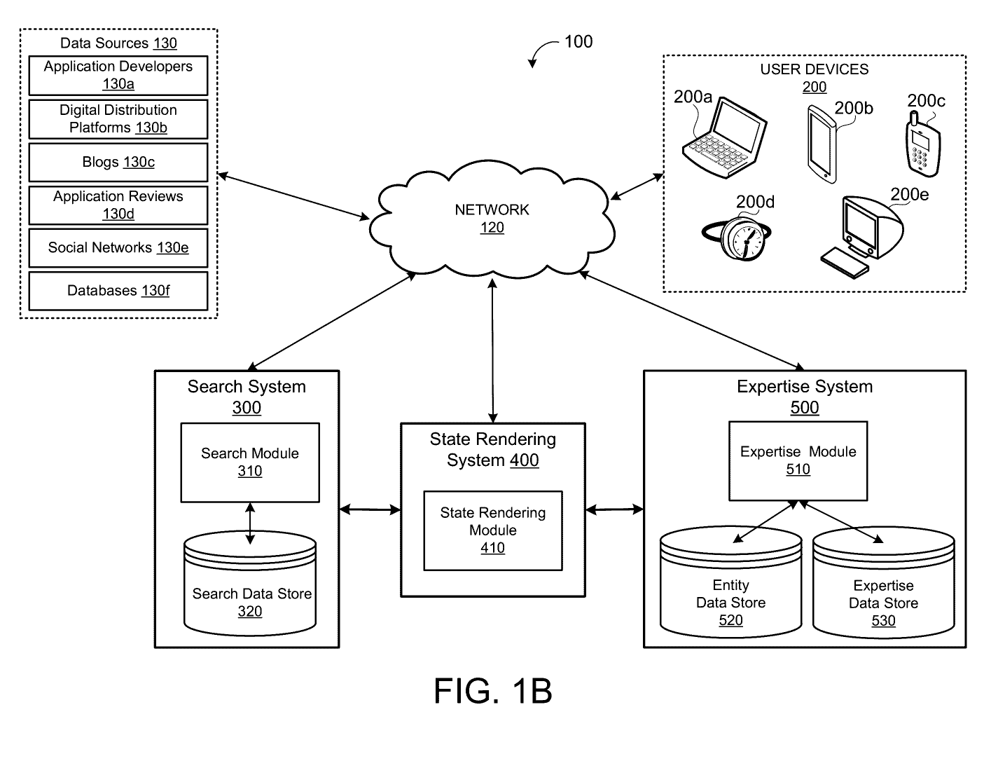

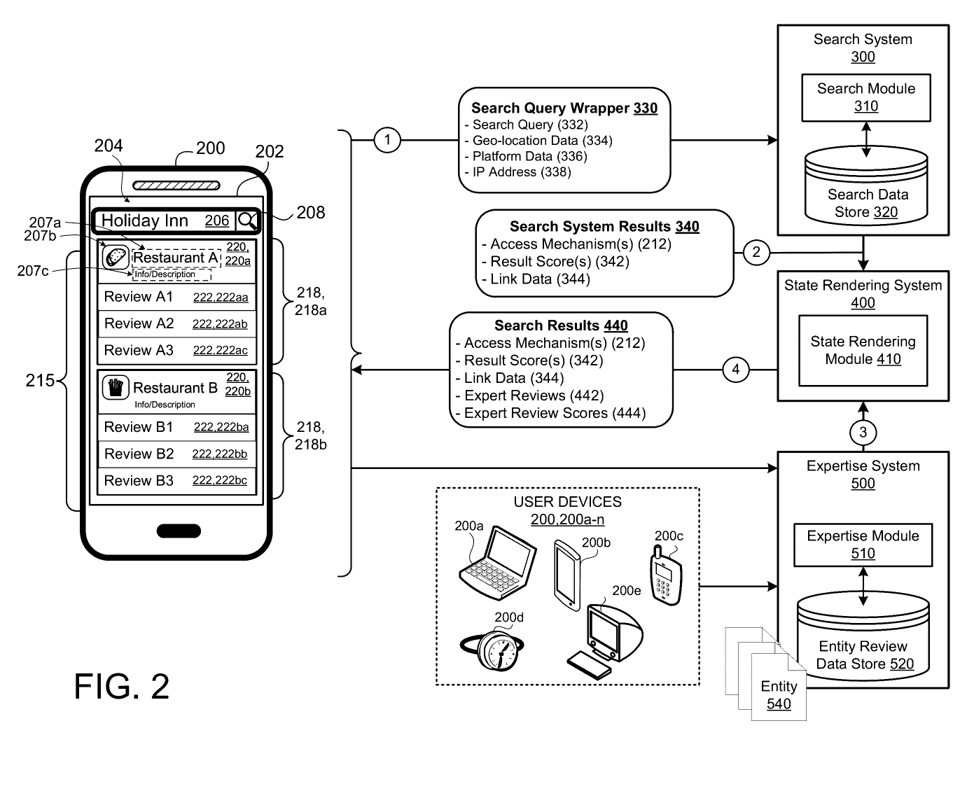

Referring to FIGS. 1 and 2, in some implementations, a system 100 includes a user device 200 associated with a user 10 in communication with a remote system 110 via a network 120. The remote system 110 may be a distributed system (e.g., cloud environment) having scalable/elastic computing resources 112 and/or storage resources 114. The user device 200 and/or the remote system 110 may implement a search system 300, a state rendering system 400, and/or and expertise system 500 that optionally receives data from one or more data sources 130 or one or more other user devices 200. In some implementations, the search system 300, the state rendering system 400, and/or and the expertise system 500 communicate with the one or more user devices 200, and the data sources(s) via the network 120. The network 120 may include various types of networks, such as a local area network (LAN), wide area network (WAN), and/or the Internet. As shown, in some implementations, the state rendering system 400 and/or the expertise system are separate from the user device 200; while in other implementations, the state rendering system 400 and/or the expertise system 500 are part of the search system 300.

The data sources 130, 130a-f may be sources of data, which the search system 300 (e.g., the search module 310) may use to generate and update the data store 320. In addition, the state rendering system 400 and/or the expertise system 500 may also use the data sources 130 to update the entity review data store 520. The data retrieved from the data sources 130 can include any type of data related to application functionality and/or application states. Data retrieved from the data sources 130 may be used to create and/or update one or more databases, indices, tables (e.g., an access table), files, or other data structures included in the data store 320. For example, application state records 600 may be created and updated based on data retrieved from the data sources 130. In some examples, some data included in a data source 130 is manually generated by a human operator. Data included in the application state records 600 may be updated over time so that the search system 300 provides up-to-date results. In addition, the entity review data store 520 may update the entities 540 based on data retrieved from the data sources 130, since entities are constantly being updated.

The data sources 130 may include a variety of different data providers. The data sources 130 may include data from application developers 130a, such as application developers' websites and data feeds provided by developers. The data sources 130 may include operators of digital distribution platforms 130b configured to distribute native applications 210a to user devices 200. Example digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications 210. Additionally, the data sources 130 may include social networking sites 130e, such as “FACEBOOK®” by Facebook. Inc. (e.g., Facebook posts) and “TWITTER®” by Twitter Inc. (e.g., text from tweets). Data sources 130 may also include online databases 130f that include, but are not limited to, data related to movies, television programs, music, and restaurants. Data sources 130 may also include additional types of data sources in addition to the data sources described above. Different data sources 130 may have their own content and update rate.

The user device 200 may be any computing device capable of displaying on a device display 202 by way of the GUI 204 one or more cards 218 associated with one or more applications 210 installed on the user device 200, where the applications provide results 440 that include user reviews. In addition, the computing device is capable of executing the one or more installed applications 210. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances).

The user devices 200 may use a variety of different operating systems 216. In examples where a user device 200 is a mobile device, the user device 200 may run an operating system including, but not limited to, ANDROID® developed by Google Inc., IOS® developed by Apple Inc., or WINDOWS PHONE® developed by Microsoft Corporation. Accordingly, the operating system 216 running on the user device 200 may include, but is not limited to, one of ANDROID®, IOS®, or WINDOWS PHONE®. In an example where a user device 200 is a laptop or desktop computing device, the user device 200 may run an operating system including, but not limited to, MICROSOFT WINDOWS® by Microsoft Corporation, MAC OS® by Apple, Inc., or Linux. User devices 200 may also access the search system 300, the state rendering system 400, and/or and the expertise system 500 while running operating systems 216 other than those operating systems 216 described above, whether presently available or developed in the future.

A software application 210 may refer to computer software that, when executed by a computing device, causes the computing device to perform a task. In some examples, a software application 210 is referred to as an “application”, an “app”, or a “program”. Example software applications 210 include, but are not limited to, word processing applications, spreadsheet applications, messaging applications, media streaming applications, social networking applications, and games.

Applications 210 may be executed on a variety of different user devices 200. In some examples, a native application 210a is installed on a user device 200 prior to a user 10 purchasing the user device 200. In other examples, the user 10 may download and install native applications 210a on the user device 200.

The functionality of an application 210 may be accessed on the computing device 200 on which the application 210 is installed. Additionally or alternatively, the functionality of an application 210 may be accessed via a remote computing device 112. In some examples, all of an application's functionality is included on the computing device 112, 200 on which the application 210 is installed. These applications 210 may function without communication with other computing devices 112, 200 (e.g., via the Internet). In other examples, an application 210 installed on a computing device 200 may access information from other remote computing devices 112 during operation. For example, a weather application installed on a computing device 200 may access the latest weather information via the Internet and display the accessed weather information to the user 10 through the installed weather application. In still other examples, a web-based application 210b (also referred to herein as a web application) may be partially executed by the user's computing device 200 and partially executed by a remote computing device 112. For example, a web application 210b may be an application 210 that is executed, at least in part, by a web server and accessed by a web browser (e.g., a native application 210a) of the user's computing device 200. Example web applications 210b may include, but are not limited to, web-based email, online auctions, and online retail sites.

In general, the user device 200 may communicate with the search system 300, the state rendering system 400, and/or and the expertise system 500 using any software application 210 that can transmit search queries 206 to the systems 300, 400, 500. In some examples, the user device 200 runs a native application 210a that is dedicated to interfacing with the search system 300, such as a native application 210a dedicated to searches (e.g., a search application 214). In some examples, the user device 200 communicates with the search system 300 using a more general application 210, such as a web-browser application 210b accessed using a web browser native application 210a. Although the user device 200 may communicate with the search system 300, the state rendering system 400, and/or and the expertise system 500 using the native search application 214 and/or a web-browser application 210b, the user device 200 may be described hereinafter as using the native search application 214 to communicate with the search system 300, the state rendering system 400, and/or and the expertise system 500. In some implementations, the functionality attributed to the search application 214 (which includes executing a search of the query analysis system 300 in parallel with a search of the search system 300) is included as a searching component of a larger application 210 that has additional functionality. For example, the functionality attributed to the search application 214 may be included as part of a native application 210a or a web application 210b as a feature that provides search capabilities.

Referring to FIG. 2, in some implementations, the user device 200 receives, via a graphical user interface (GUI) 204, a search query 332 from the user 10. The search query 332, which may include text, numbers, and/or symbols (e.g., punctuation), is entered into the user device 200 by the user 10. For example, the user 10 may enter the search query 332 into a search field 206 (e.g., a search box) of the GUI 204 of a search application 214 running on the user device 200. In some examples, the user 10 selects a search button 208 to initiate execution of the search. A user 10 may enter a search query 332 using a touchscreen keypad, a mechanical keypad, a speech-to-text program, or other form of user input. In general, a search query 332 may be a request for information retrieval (e.g., search results) from the search system 300. For example, a search query 332 may be directed to retrieving a list 215 of cards 218 associated with application functionality or application states in examples where the search system 300 is configured to generate the list 215 of cards 218 each including one or more access mechanisms 212 associated with the card 218. For example, a card 218 may be associated with an entity 540 (e.g., a restaurant), and the card 218 includes one or more access mechanisms 212 providing one or more reviews relating to the entity 540. A search query 332 directed to retrieving a list 215 of cards 218 to application functionality may indicate a user's desire to access one or more functionality (i.e., one or more user reviews) of one or more applications 204 described by the search query 332.

In some examples, the search query 332 is included in a query wrapper 330. The query wrapper 330 may include additional data along with the search query 332. For example, the query wrapper 330 may include geo-location data that indicates the location of the user device 200, such as latitude and longitude coordinates. The user device 200 may include a global positioning system (GPS) receiver that generates the geo-location data 334 transmitted in the query wrapper 330. The query wrapper 330 may also include an IP address 338, which the search module 310 may use to determine the location of the user device 200. In some examples, the query wrapper 330 also includes additional data, including, but not limited to, platform data 336 (e.g., version of the operating system 216, device type, and web-browser version), an identity of a user of the user device 200 (e.g., a username), partner specific data, and other data.

The user device 200 transmits the search query 332 included in a query wrapper 330 to the search system 300. When the search system 300 receives the search query 332, the search system 300 executes a search of the search data store 320 based on the search query 332. The search system 300 may implement a search based on the search query 332 (included in the search query wrapper 330) that includes search criteria received from the user device 200. The search system 300 generates search system results 340 in response to the received search query 332 and transmits the search system search results 440 to state rendering system 400. Search system results 340 include various access mechanisms 212 for accessing applications 204 or functionality of applications 204 relevant to the search query 332 of the user 10. In response to selection of an access mechanism 212, the user device 200 may launch an application 210 referenced in the application access mechanism 212 and perform the one or more operations indicated in the application access mechanism 212. The search system 300 may include the query analysis system 300.

In some implementations, the search system 300 includes a search module 310 in communication with the search data store 320. The search data store 320 may include one or more databases, indices (e.g., inverted indices), tables, files, or other data structures, which may be used to implement the techniques of the present disclosure. The search module 310 receives a search query wrapper 330 and generates search system results 340 based on the data included in the data store 320. In some implementations, the search module 310 receives a query wrapper 330 from the user device 200 or from the query analysis system 300 and performs a search for application state records 600 included in the search data store 320 based on data included in the query wrapper 330, such as a search query 332. The application state records 600 include one or more access mechanisms 212 that the user device 200 can use to access different functions for a variety of different applications, such as native applications 210a installed on the user device 200. The search module 310 transmits search system results 340 including a list of access mechanisms 212 to the state rendering system 400, which in turn updates the search system results 340 to search results 440 by including scored expert reviews 444 that are scored 444, allowing the user device 200 to display to the user 10 the most helpful and relevant reviews provided by users 10 that have been identified as experts in the field (relating to the entity 540 associated with the search query 332.

The user device 200 receives the search results 440 including the expertise information (e.g., expert reviews 442 and expert review scores 444) received from the expertise system 500 and generates one or more cards 218. Each card 218 includes an entity 540 and reviews relating to the entity 540. For example, the entity 540 (e.g., a restaurant type) may be associated with an access mechanism 212. Each displayed card 218 (e.g., search result) includes one or more access mechanisms 212 (e.g., name user-selectable links 220 and reviews user-selectable links 222), the cards 218 being the search results in response to the query 332 inputted by the user 10. Therefore, the displayed search results 215 include search system results 340 and expert reviews 442 added by the state rendering system 400 to the search system search results 440 and retrieved from the expertise system 500.

The user device 200 receives the search system search results 440 from the search system 300 and displays the search results 440 to the user 10 as one or more user-selectable links 222, 220 (also referred to as links). Each user-selectable link 220, 222 includes one of the access mechanisms 212 included in the search system results 340 and/or included in the expertise system 500 that was included in the search system results 340 resulting in the search results 440. The search system results 340 and the state rendering system 400 may return an access mechanism 212 associated with specific link data 344. The user device 200 uses the link data 344 to generate and display the one or more user-selectable link(s) 220, 222 associated with each of the search results 440 or cards 218. Upon a user's selection of a user-selectable link 220, 222, the web access mechanism 212 may direct the user device 200 to open a state of an application 210.

The user device 200 generates user-selectable links 220, 222 based on the received search results 440 (e.g., links 220, 222). Each user-selectable link 220, 222 displayed to the user 10 may include an access mechanism 212. The user 10 may select a user-selectable link 220, 222 on the user device 200 by interacting with the link 220, 222 (e.g., touching or clicking the link). In response to selection of a link 220, 222, the user device 200 may launch a corresponding software application 210 (e.g., a native application 210a or a web-browser application 210b) referenced by the access mechanism 212 and perform one or more operations indicated in the access mechanism 212. For example, the user-selectable links 220, 222 are grouped by card 218. Each card 218 includes a header that includes the name user-selectable link 220 and shows the title 207a of the card 218 (e.g., a name of the restaurant) and in some examples also includes an icon 207b associated with the title (e.g., a restaurant icon) or the application associated with the card 218. In addition, and in some examples, the header also includes a brief description 207c of the title (e.g., contact information). Under the header, each card 218 includes a list of reviews, each associated with a review user-selectable link 222. Each review user-selectable link 222, when selected, gives the user 10 a review provided by an expert (determined as an expert based on the expertise system 500) associated with the card 218.

Access mechanisms 212 may include at least one of a native application access mechanism 212a (hereinafter “application access mechanism”), a web access mechanism 212b, and an application download mechanism 212c. The user device 200 may use the access mechanisms 212 to access functionality of applications 204. For example, the user 10 may select a user-selectable link 220, 222 including an access mechanism 212 in order to access functionality of an application 210 indicated in the user-selectable link 220, 222. The search module 310 may transmit one or more application access mechanisms 212a, one or more web access mechanisms 212b, and one or more application download mechanisms 212c to the user device 200 in the search results 340, 440.

An application access mechanism 212a may be a string that includes a reference to a native application 210a and indicates one or more operations for the user device 200 to perform. If a user 10 selects a user-selectable link 220, 222 including an application access mechanism 212a, the user device 200 may launch the native application 210a referenced in the application access mechanism 212a and perform the one or more operations indicated in the application access mechanism 212a.

An application access mechanism 212a includes data that the user device 200 can use to access functionality provided by a native application 210a. For example, an application access mechanism 212a can include data that causes the user device 200 to launch a native application 210a and perform a function associated with the native application 210a. Performance of a function according to the access mechanism 212 may set the native application 210a into a specified state. Accordingly, the process of launching a native application 210a and performing a function according to an application access mechanism 212a may be referred to herein as launching the native application 210a and setting the native application 210a into a state that is specified by the application access mechanism 212a. In some examples, an application access mechanism 212a for a restaurant reservation application can include data that causes the user device 200 to launch the restaurant reservation application and assist in making a reservation at a restaurant. In such examples, the restaurant reservation application may be set in a state that displays reservation information to the user 10, such as a reservation time, a description of the restaurant, and user reviews. In additional examples, an application access mechanism 212a for an internet media player application can include data that causes the user device 200 to launch the internet media player application and stream media from the Internet. In such examples, the internet media player application may be set in a state that displays information regarding the media (e.g., music) being streamed, such as a song name, an artist, or an album name.

Application access mechanisms 212a may have various different formats and content. The format and content of an application access mechanism 212a may depend on the native application 210a with which the application access mechanism 212 is associated and the operations that are to be performed by the native application 210a in response to selection of the application access mechanism 212a. For example, an application access mechanism 212a for an internet music player application may differ from an application access mechanism 212a for a shopping application. An application access mechanism 212a for an internet music player application may include references to musical artists, songs, and albums, for example. The application access mechanism 212a for an internet music player application may also reference operations, such as randomizing a list of songs and playing a song or album. An application access mechanism 212a for a shopping application may include references to different products that are for sale. The application access mechanism 212a for the shopping application may also include references to one or more operations, such as adding products to a shopping cart and proceeding to a checkout.

The search system 300, state rendering system 400 and/or the expertise system 500 may transmit additional data in the search results 340, 440 along with the application access mechanisms 212a. For example, the search system 300 may transmit data (e.g., text and/or images), which may be used by the user device 200 to generate user-selectable links 220, 222 in the search results 440. A user-selectable link 220, 222 may include text and/or images that the user 10 may select (e.g., touch) via a user interface 204 displayed on a display 202 (e.g., a display or touch screen) of the user device 200. Each user-selectable link 220, 222 may be associated with an application access mechanism 212a such that when the user 10 selects a link 220, 222, the user device 200 launches the native application 210a referenced in the application access mechanism 212a and performs the one or more operations indicated in the application access mechanism 212a. The text and/or images of a link 220, 222 displayed to the user 10 may indicate the operations that may be performed in response to selection of the link 220, 222. For example, if the name user-selectable link 220 is to a song in a music playing application, the text and/or images may identify the music application that may be launched by the user device 200 and the song that may be played by the music playing application when the user 10 selects the review user-selectable link 222. If the review user-selectable link 222 is to review the song in the music playing application, the text and/or images may identify the music application that may be launched by the user device 200 and the reviews associated with the song when the user 10 selects the review user-selectable link 222.

The user 10 may select a user-selectable link 220, 222 that causes the user device 200 to launch the native application 210a identified in the user-selectable link 220, 222 and perform one or more operations according to the application access mechanism 212a associated with the link 220, 222. Put another way, when the user 10 selects a user-selectable link 220, 222, the user device 200 launches a native application 210a and sets the native application 210a into a state defined by the application access mechanism 212a associated with the link 220, 222. In general, a state of a native application 210a may refer to the operations and/or the resulting outcome of the native application 210a in response to selection of a link 220, 222. A state of a native application 210a may also be referred to herein as an “application state.”

An application state specified by an application access mechanism 212a may depend on the functionality provided by the native application 210a. For example, if a native application 210a is configured to retrieve and display information from the Internet, the native application 210a can be set into a state in which the native application 210a retrieves information from the Internet and displays information to the user 10. In another example, if a native application 210a is configured to play media (e.g., music and/or video) from the Internet, the native application 210a can be set into a state in which the native application 210a is playing a song or a movie from the Internet. In another example, if a native application 210a is configured to make restaurant reservations, the native application 210a can be set into a state in which the native application 210a displays available restaurant reservations to the user 10.

A web access mechanism 212b may include a resource identifier that includes a reference to a web resource (e.g., a page of a web application/website). For example, a web access mechanism 212b may include a uniform resource locator (URL) (i.e., a web address) used with hypertext transfer protocol (HTTP). If a user 10 selects a user-selectable link 220, 222 including a web access mechanism 212b, the user device 200 may launch the web browser application 210b and retrieve the web resource indicated in the resource identifier. Put another way, if a user 10 selects a user-selectable link 220, 222 including a web access mechanism 212b, the user device 200 may launch a corresponding web-browser application 210b and access a state (e.g., a page) of a web application/website. In some examples, web access mechanisms 212b include URLs for mobile-optimized sites and/or full sites.

The web access mechanism 212b included in an application state record 600 may be used by a web browser to access a web resource that includes similar information and/or performs similar functions as would be performed by a native application 210a that receives an application access mechanism 212a of the application state record 600. For example, the web access mechanism 212b of an application state record 600 may direct the web-browser application 210b of the user device 200 to a web version of the native application 210a referenced in the application access mechanisms 212a of the application state record 600. Moreover, if the application access mechanisms 212 included in an application state record 600 for a specific Mexican restaurant cause each application edition to retrieve information for the specific Mexican restaurant, the web access mechanism 212b may direct the web-browser application 210b of the user device 200 to a web page entry for the specific Mexican restaurant.

An application download mechanism 212c may indicate a location (e.g., a digital distribution platform 130b) where a native application 210a can be downloaded in the scenario where the native application 210a is not installed on the user device 200. If a user 10 selects a link 220, 222 including an application download mechanism 212a, the user device 200 may access a digital distribution platform from which the referenced native application 210a may be downloaded. The user device 200 may access a digital distribution platform 130b using at least one of the web-browser application 210b and one of the native applications 210a.

The search module 310 performs a search for application state records 600 included in the search data store 320 in response to the received search query wrapper 330 (e.g., in response to the search query 332 and the geo-location data 334). In some implementations, the search module 310 generates result scores 442 for application state records 600 identified during the search. The result score 442 associated with an application state record 600 may indicate the relevance of the application state record 600 to the search query 332. A higher result score 442 may indicate that the application state record 600 is more relevant to the search query 332. The search module 310 may retrieve access mechanisms 212 from the scored application state records 600. The search module 310 can transmit a result score 442 along with an access mechanism 212 retrieved from a scored application state record 600 in order to indicate the rank of the access mechanism 212 among other transmitted access mechanisms 212.

An application access mechanism 212a included in an application state record 600 may be an application resource identifier or a string that includes a reference to a native application 210a and/or indicates one or more operations for execution by the native application 210a on the user device 200. An application resource identifier is a string having an application specific scheme in some examples. For example, the application resource identifier may include a reference to a native application 210a, a domain name, and a path to be used by the native application 210a to retrieve and display information to the user 10. In some examples, an application resource identifier is an application specific resource identifier that is defined by the developer of the application 210. In this example, the search application 214 receives the application resource identifier and the operating system 216 may send the application resource identifier to the native application 210a referenced in the application resource identifier. The native application 210a referenced in the application resource identifier launches and is set into the state specified by the application resource identifier.

In some examples, the application access mechanism 212a includes operations for the user device 200 to perform in addition to the operation(s) indicated in the application resource identifier. For example, the search application 214, the operating system 216, and/or a native application 210a on the user device 200 may perform the operations included in the application access mechanism 212a. In some examples, a script includes the operations. Examples of operations may include, but are not limited to, launching a native application 210a, creating and sending a search request 332 (via a search wrapper 330) to an application server, setting a current geographic location in a native application 210a, making a restaurant reservation, sending a text message, and adding an appointment to a calendar.

In some examples, an application access mechanism 212a does not include an application resource identifier. Instead, the application access mechanism 212a includes one or more operations that reference a native application 210a and indicate one or more operations for execution by the user device 200. The one or more operations may include instructions for at least one of the search application 214, the operating system 216, and/or a native application 210a on the user device 200. In response to selection of the application access mechanism 212a, the user device 200 may perform the operations included in the application access mechanism 212a. In some examples, the operations are included in a script.

In some examples, an application function is not accessible using an application resource identifier. For example, a function of the application may not include a corresponding application resource identifier that the application 210 may use to perform the function. As another example, some applications 204 may not be configured to receive application resource identifiers. In these examples, an application access mechanism 212 for the native application 210a can include one or more operations that cause the native application to perform the function that may not otherwise be accessible using an application resource identifier. For example, the search application 214 may receive the one or more operations and execute the one or more operations to set the native application 210a into the desired application state. In some examples, the one or more operations include launching the native application 210a along with additional operations for the native application 210a to perform. For example, the search application 214 may initially trigger the native application 210a to start and then wait for a period of time for the native application 210a to start. Then the search application 214 may perform additional operations included in the received application access mechanism 212, such as issuing a search instruction to the native application 210a.

In still other examples, a native application 210a may be configured to directly receive the operations transmitted by the system 100. In these examples, the native application 210a may be launched according to the application access mechanism 212 and then the launched native application 210a may directly perform the operations received from the system 100.

A single native application 210a can provide a variety of different functionalities. For example, a restaurant reservation application can access reviews for a variety of different restaurants and set up reservations at a variety of different restaurants. Similarly, a travel application can book hotels, book flights, and provide reviews for different travel destinations. The different functionalities associated with a single native application may be accessed using a plurality of different application access mechanisms. For example, with respect to the restaurant reservation application, the search data store 320 may include application state records 600 having different application access mechanisms 212 for accessing different restaurant reviews and setting up reservations. Similarly, the search data store 320 may include application state records 600 having different application access mechanisms 212 for booking hotels, booking flights, and accessing reviews for different travel destinations.

The application access mechanisms 212 for a single native application 210a may vary in complexity. In some examples, the application access mechanisms 212 causes a native application 210a to launch (e.g., the operating system 216 may be instructed to launch the application 210) and then perform additional operations after launching, as described above. In other examples, application access mechanisms 212 may cause an application 210 to launch into a default state (e.g., a default homepage) without performing any additional operations. An application state record 600 including an application access mechanism 212 that causes an application 210 to launch into a default state may be thought of as an access mechanism 212 that is related to the native application 210a, but not any particular state, which may be accessed by the application 210.

The search module 310 may transmit additional data to the state rendering system 400 along with the access mechanisms 212 and the result score(s) 342. For example, the search module 310 may transmit data (e.g., text and/or images) to be included in the links 220, 222. Data for the links 220, 222 (e.g., text and/or images) may be referred to herein as “link data” (e.g., link data 344). The user device 200 displays the links 220, 222 to the user 10 based on received link data 344. Each link 220, 222 may be associated with an access mechanism 212 included in the search results 340, 440, such that when a user 10 selects a link 220, 222, the user device 200 launches the application 210 referenced in the access mechanism 212 and sets the application 210 into the state specified by the access mechanism 212.

With reference to FIG. 2, the user device 200 may receive a set of search results 440 from the search module 310 and/or state rendering system 400 in response to transmission of the search query wrapper 330. The GUI 204 of the search application 214 displays (e.g., renders) the search results 440 received from the search module 310 and/or the state rendering system 400. The search application 214 may display the search results 440 to the user 10 in a variety of different ways, depending on what information is transmitted to the user device 200. In examples where the search results 440 include a list of access mechanisms 212 and link data 344 associated with the access mechanisms 212, the search application 214 may display the search results 340, 440 to the user 10 as a list 215 of links 220, 222 including text and images. The text and images in the links 220, 222 may include application names associated with the access mechanisms 212, text describing the access mechanisms 212, images associated with the application 210 referenced by the access mechanisms 212 (e.g., application icons), and images associated with the application state (e.g., application screen images) defined by the access mechanisms 212.

In some implementations, the search application 214 displays the search results 340, 440 as a list 215 of links 220, 222 arranged under the search field 206 in which the user 10 entered the search query 332. Moreover, the search application 214 may arrange the links 220, 222 in order based on result scores 442 associated with the access mechanisms 212 included in the header links 220.

Each of the links 220, 222 includes link data 344. For example, each of the links 220, 222 may include an image (e.g., an icon) and text (e.g., an application or business name) that may describe an application and a state of an application. Each of the links 220, 222 may include an access mechanism 212 so that if a user 10 selects one of links 220, 222, the user device 200 launches the application 210 and sets the application 210 into a state that is specified by the access mechanism 212 associated with the selected link 220, 222. In some implementations, the user device 200 arranges the links 220, 222 based on result scores associated with the access mechanisms 212 included in the links 220, 222.

In some examples, user devices 200 communicate with the search system 300 and/or the state rendering system 400 via a partner computing system (not shown). The partner computing system may be a computing system of a third party that may leverage the search functionality of the search system 300, the state rendering system 400, and/or the expertise system 500. The partner computing system may belong to a company or organization other than that which operates the search system 300, the state rendering system 400, and/or the expertise system 500. Example third parties which may leverage the functionality of the search system 300, the state rendering system 400, and/or the expertise system 500 may include, but are not limited to, internet search providers and wireless communications service providers. The user devices 200 may send search queries to the search system 300, the state rendering system 400, and/or the expertise system 500 and receive search results 440 via the partner computing system. The partner computing system provides a user interface to the user devices 200, in some examples, and/or modify the search experience provided on the user devices 200.

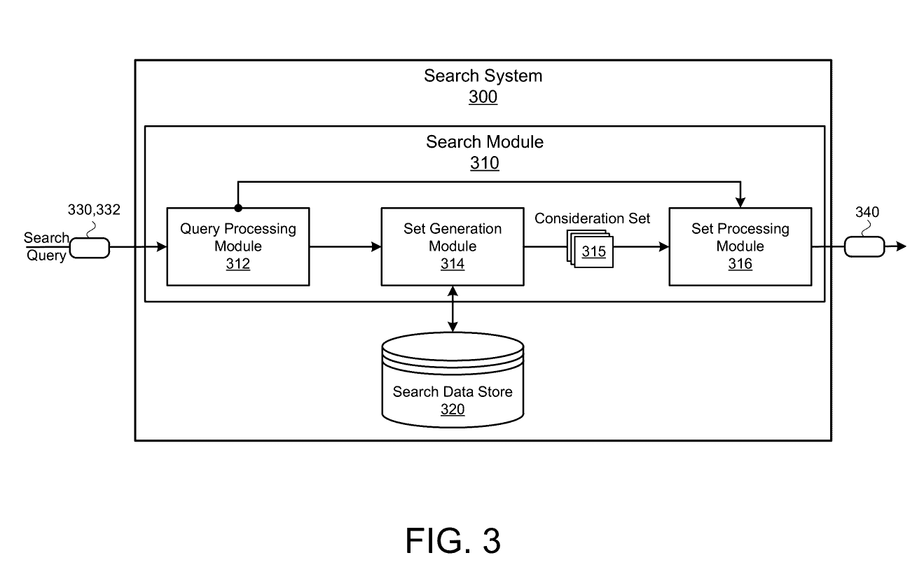

FIG. 3 illustrates an examples search system 300. As shown, the search module 310 includes a query processing module 312, a set generation module 314, and a set processing module 316. The query processing module 312 receives the search query 332 (e.g., from the user device 200 or the query analysis system 300) and processes the search query 332 (e.g., performs any of tokenization, filtering, stemming, synonymization, and stop word removal with respect to the search query 332). The set generation module 314 then identifies one or more application state records 600 included in the search data store 320 using the (e.g., processed) search query 332. For example, the set generation module 314 may identify the application state records 600 using the search query 332 as inputs to LUCENE® information retrieval software developed by the Apache Software Foundation. Specifically, the set generation module 314 may identify the application state records 600 based on matches between terms of the search query 332 and terms of application state information 604 (ASI) included in the application state records 600.

The identified application state records 600 may be referred to herein as a consideration set 315. The consideration set 315 of application state records 600 may refer to the application state records 600 that are to be scored by the set processing module 316. The set generation module 314 may determine the geo-location of the user device 200 based on data included in the search query wrapper 330. In additional examples, if the query analysis module 310 detects a query-specified location, the set generation module 414 uses the query-specified location as the search location. In some examples, the set generation module 314 uses the geo-location of the user device 200 as the search location (e.g., to filter application state records 600 based on location).

The set processing module 316 may score the consideration set 315 to generate one or more application state IDs 602 that identify the application state records 600 and transmits the application state IDs 602 to the search result generation module 420, as described above. The set processing module 316 may score the application state records 600 in the consideration set 315 in order to generate a set of search results 440. The scores 442 associated with the application state records 600 may be referred to as “result scores.” The set processing module 316 may determine a result score 342 for each of the application state records 600 in the consideration set 315. The result scores 342 associated with an application state record 600 may indicate the relative rank of the application state record 600 (e.g., by the access mechanisms 212) among other application state records 600. For example, a larger result score 342 may indicate that an application state record 600 is more relevant to the received search query 332.

The set processing module 316 selects application access mechanisms 212 from the selected application state records 600 (e.g., the highest scoring application state records). The set processing module 316 transmits the selected application access mechanisms 212 to the state rendering system 400, which in turn sends the search results 440 to user device 200 that generated the search query 332. The set processing module 316 may also transmit the result scores 442 associated with the selected application access mechanisms 212. For example, an application access mechanism 212 may be associated with the result score 442 of the application state record 600 from which the application access mechanism 212 was selected.

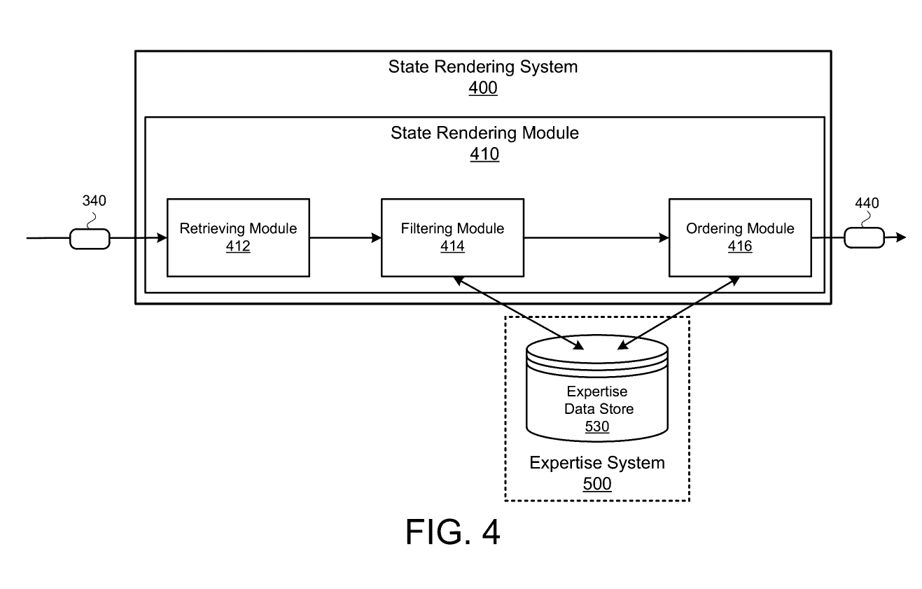

FIG. 4 illustrates a state rendering system 400. As shown, the state rendering system 400 includes a retrieving module 412, a filtering module 414, and an ordering module 416. The retrieving module 412 receives the search system results 340 and for each search result 340 associated with an access mechanism 212, the retrieving module 412 identifies the search results 340 that include one or more reviews. Then, the filtering module 414 filters the reviews that are associated with one or more entities 540, and for each review that is associated with an entity 540, determines the user profiles 800 that are experts in the field of that specific entity 540. Finally, the ordering module 416 orders the reviews associated with each search result 440 (or card 218) by the expertise of the user profile 800 associated with the review.

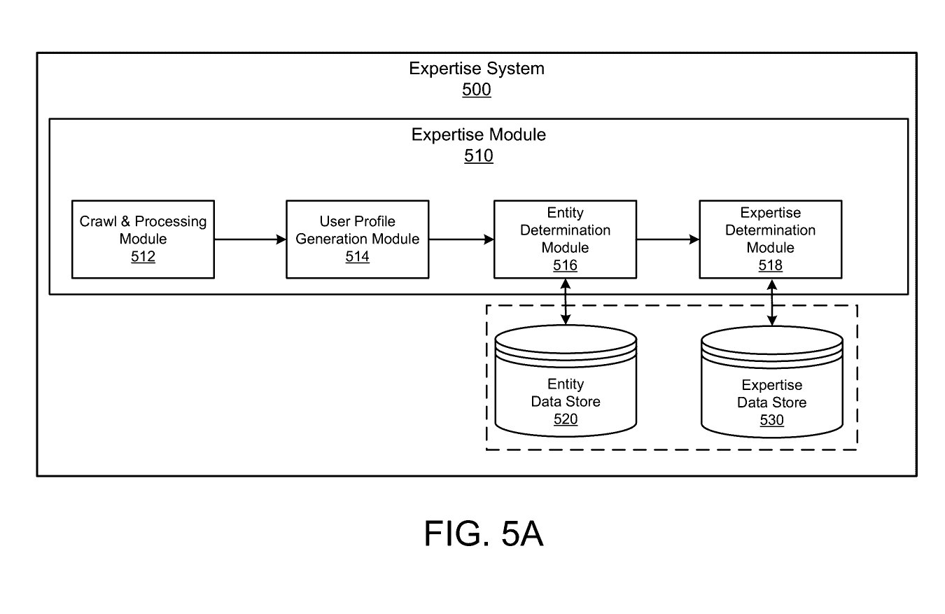

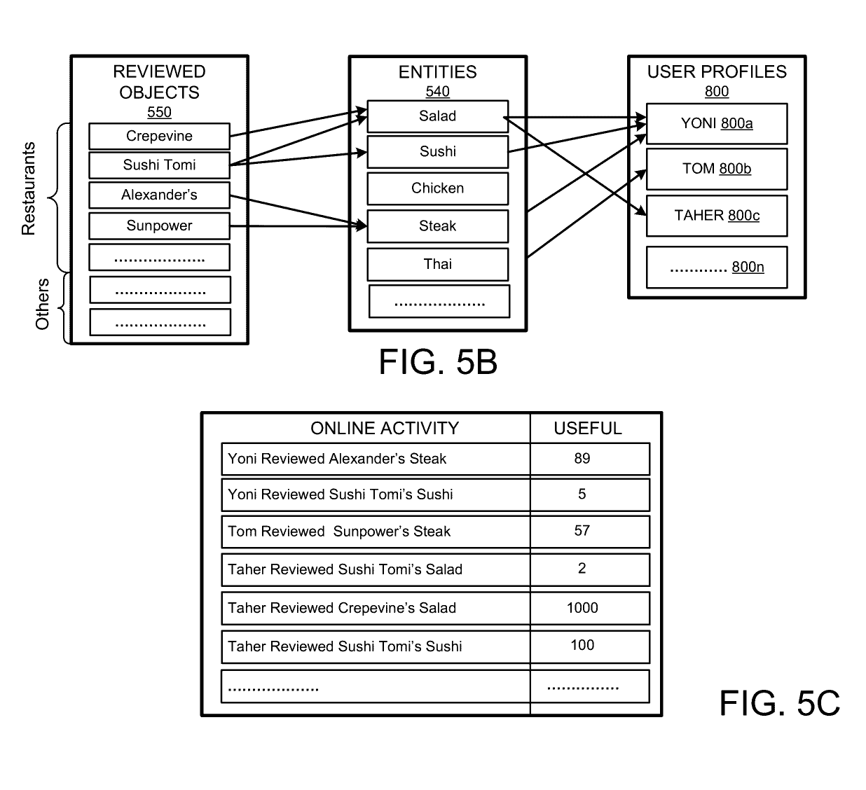

FIG. 5A illustrates an expertise system 500. The expertise system 500 determines a degree of expertise of users that provide reviews by way of the web or applications 210. For example, an expert is a user 10 who knows about a specific subject more than other users 10, is vocal about the subject by writing reviews. An expert may be an expert in one or more subjects or entities. An entity may be a business or place with a geolocation or person or event (e.g., restaurants, bars, gas stations, supermarkets, movie theaters, doctor offices, sports team, movie star, celebrity, politician, parks, and libraries, etc.). If the entity is “Salad,” a salad expert is a user 10 who writes reviews about salads, mentions salads in his/her posts and applications, searches for salads, etc. Therefore, when a non-expert user enters the word “Salad” in the query 206, the salad expert's reviews relating to salad may be included in the search results 440 (e.g., cards 218) displayed to the user 10.

The expertise system 500 is configured to crawl the web and process the retrieved data, build user profiles based on the retrieved data, link entities with each review associated with a user profile, and determine the expertise of each user 10 based on the user profile and one or more features. The expertise system 500 includes a crawl and processing module 512, a user generation module 514, an entity determination module 516 in communication with an entity data store 520, and an expertise determination module 518 in communication with an expertise data store.

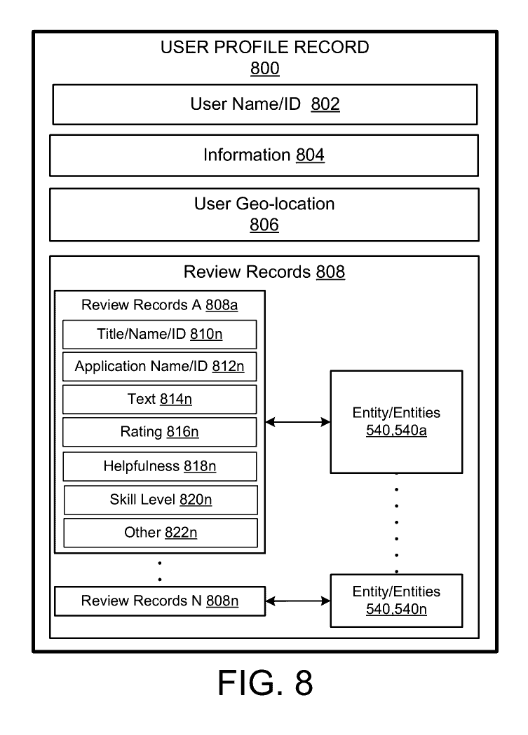

The crawl and processing module 512 is configured to crawl websites and/or applications that provide reviews. For example, the crawl and processing module 512 may crawl AMAZON® website for reviews relating to products sold, or TRIPADVISOR® for reviews relating to destination, activities, and/or restaurants. In addition, the crawl and processing module 512 determines user's public activities. Based on user online activities, such as their reviews, comments, blogs, etc., the system 100 builds up connections between users 10 and entities 540 (e.g., salad, sushi, steak), as shown in FIG. 5B. The crawl and processing module 512 processes the crawled data so that the user profile generation module 514 can generate a user profile 800 (FIG. 8) associated with reviewers (e.g., users 10).

For each user 10, the user generation module 514 generates a user profile 800 by identifying reviews written by the user 10. In some examples, the user profile 800 is associated with one or more websites and/or one or more applications. Therefore, the expertise system 510 identifies users 10 who provide reviews on, for example, AMAZON® and EBAY®, and generates one user profile 800. Therefore, by expanding the user profile 800 to include profiles 800 of the same user 10 in two or more websites or applications, the user generation module 514 may provide a better user profile 800. The user generation module 514 may identify two user profiles 800 and link them based on several factors, including but not limited, user name, information that the user 10 provided with each review (e.g., age, gender, location, etc.). Therefore, if two user profiles 800, each associated with one application or website, have the same username or general location, there is a high probability that the user profiles 800 are associated with the same user 10.

The system 100 may acquire user profiles 800 and online activities by crawling the applications 210 and generating a user profile 800 based on their individual profiles within an application 210 and online activities. For example, consider YELP® as a source and ‘food’ as an entity, the crawl and processing module 512 can crawl every restaurant page for every restaurant within YELP®, crawl all the profiles that reviewed the restaurant and categorize what the users 10 reviewed by query categorization or tags, etc. For example, people tag themselves on the images posted online, such as, “I reviewed salad”, “I reviewed steak”, and so on. The crawl and processing module 512 can also match the reviews to categories by taking hints of what the domain is. For example, in terms of Yelp's restaurant reviews, the system 100 can limit the amount of entities associated with a restaurant, food, and cuisines entity types first. Then the expertise system 500 can go to a specific restaurant and look at the reviews and analyze the text of the reviews by determining what exactly the users 10 reviewed, for instance, “are they mentioning the work ‘chicken’, ‘steak’, or . . . ?”

Users can like or dislike the entities 540. To enhance the user profiles 800, the expertise module 510 may further identify whether the comments/reviews are positive or negative. The expertise module 510 may use the sentiment analysis, looking at the words around it and identifying whether it is a positive or negative correlation.

Referring to FIG. 5B, based on the online activities of each user profile 800, the entity mapping or determination module 516 builds the connections among entities 540, user profiles 800 and objects 550 being reviewed (e.g., restaurants, items, . . . ) and stores these connections or mappings in the entity data store 520. For example, in a first user profile 800a, Yoni reviewed Alexander's steaks from Alexander's Restaurant 550. So steaks (e.g., an entity 540), Yoni's profile 800a, and Alexander's Restaurant 550 are connected or mapped to each other. Yoni also reviewed Sushi Tomi's Sushi restaurant 550. Therefore, Sushi (entity 540), Yoni's profile 800a, and Sushi Tomi Sushi restaurant 550 are connected or mapped to each other. The entity mapping or determination module 516 generates the list of user profiles 800, which entities 540 they are connected to, and which objects 550 they are reviewing.

The expertise determination module 518 is in communication with an expertise data store 530. The expertise determination module 518 identifies the experts of a field (e.g., users 10), entities 540, or a reviewed objects 550 based on the user profile 800 and the mapping data shown in FIG. 5B. One factor of identifying experts in a field is the number of connections or mappings the user profile 800 has with the particular entity 540. For example, with continued reference to FIG. 5B, the third user profile 800c associated with user “Taher” also reviewed salad (entity 540) from two reviewed objects 550 (e.g., Crepevine and Sushi Tomi restaurants). So there are two arrows pointing to the third user profile 800c associated with user “Taher” from the “salad” entity 540. A user 10 associated with a user profile 800 may review a certain entity 540 (e.g., salad) from different restaurants, and build multiple connections with this particular entity 540. Therefore, the greater the number of reviews of a user 10 associated with his/her user profile 800, the more connections he/she builds, and the more likely he/she is an expert in that particular field (e.g., the salad field).

Referring to FIG. 5C, in some implementations, many reviewed objects 550 (e.g., a restaurant) attach additional information to each of the provided reviews. The additional information may include, but is not limited to, a number of other users 10 who found a review helpful. Such information may be used as a factor for determining if a user 10 is an expert. For example, referring to FIG. 5, for Sushi Tomi's sushi restaurant 550, five people found the user profiles 800 associated with Yoni's review useful, while 100 people found the user profile 800 associated with Taher's review useful. Therefore, the user profile associated with Taher is probably more of an expert than the user profile associated with Yoni in terms of the entity 540 ‘Sushi. In some examples, only two people found Taher's review on Sushi Tomi's salad useful, while about 1000 people found his review on Crepevine's salad useful. Since Taher has reviewed Crepevine over 1000 times, then his reviews are indicative of usefulness, and Sushi Tomi only has two reviews, then it is not indicative of the helpfulness of the review.

The expertise system 500 may be configured to identify icons or pictures of reviewed objects 550 that a user 10 associated with a user profile 800 posted on the web or by way of an application. The expertise system 500 may retrieve pictures or icons posted by the identified experts and return these identified pictures or icons to display in the search results 440 (e.g., see FIG. 2, for example icon 207b or include the icon by each review (not shown)).

The expertise determination module 518 outputs user profiles 800 associated with entities 540, which allows the system 100 to receive a search query 332, identify one or more entities 540 associated with the query 332 and determine the experts associated with each entity 540.

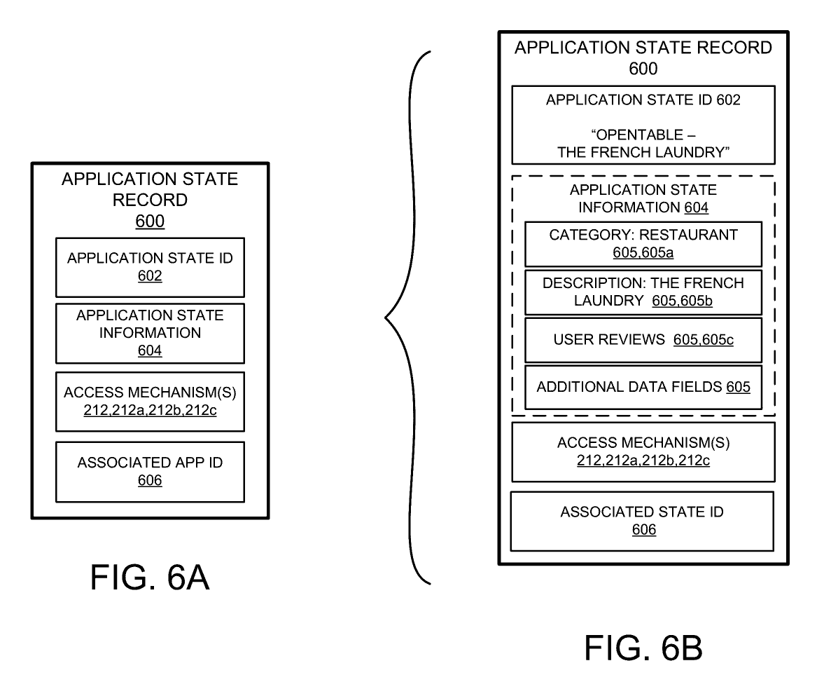

Referring to FIGS. 6A and 6B, the search data store 320 includes a plurality of different application states 600. Each application state 600 may include data related to a function of an application 204 and/or the state of the application 204 resulting from performance of the function. An application state 600 may include an application state identifier (ID) 602, application state information 604, an application identifier (ID) 606, and one or more access mechanisms 212, 212a. 212b, 212c used to access functionality provided by an application 204.

The application state ID 602 may be used to identify the application state 600 among the other application states 600 included in the search data store 320. The application state ID 602 may be a string of alphabetic, numeric, and/or symbolic characters (e.g., punctuation marks) that uniquely identifies the associated application state 600. In some examples, the application state ID 602 describes a function and/or an application state in human readable form. For example, the application state ID 602 may include the name of the application 204 referenced in the access mechanism(s) 212. In a specific example, an application state ID 602 for an internet music player application may include the name of the internet music player application along with the song name that may be played when the internet music player application is set into the state defined by the application access mechanism included in the application state. Additionally or alternatively, the application state ID 602 may be a human readable string that describes a function performed according to the access mechanism(s) 212 and/or an application state resulting from performance of the function according to the access mechanism(s) 212. In some examples, the application state ID 602 includes a string in the format of a uniform resource locator (URL) of a web access mechanism 212b for the application state 600, which may uniquely identify the application state 600. In some examples, the string includes multiple parameters used to retrieve the corresponding application state 600. In addition, some parameters may be user-generated, which means that the parameters put the application in a new application state 600 that has not been previously executed. Thus, the link 222 may not explicitly correspond to a known end result inside the application, but simply fits a known link expression that the application accepts. For example, the UBER® application may display a link 222 that uses a latitude and longitude as a parameter to determine location.

In a more specific example, if the application state 600 describes a function of the YELP® native application, the application state ID 602 may include the name “Yelp” along with a description of the application state described in the application state information 604. For example, the application state ID 602 for an application state 600 that describes the restaurant named “The French Laundry” may be “Yelp—The French Laundry.” In an example where the application state ID 602 includes a string in the format of a URL, the application state ID 602 may include the following string “http://www.yelp.com/biz/the-french-laundry-yountville-2?ob=1” to uniquely identify the application state 600. In additional examples, the application state ID 602 may include a URL using a namespace other than “http://,” such as “func://,” which may indicate that the URL is being used as an application state ID 602 in an application state. For example, the application state ID 602 may include the following string “func://www.yelp.com/biz/the-french-laundry-yountville-2?ob=1.”

The application state information 604 may include data that describes an application state into which an application 204 is set according to the access mechanism(s) 212 in the application state 600. Additionally or alternatively, the application state information 604 may include data that describes the function performed according to the access mechanism(s) 212 included in the application state 600. The application state information 604 may include text, numbers, and symbols that describe the application state. The types of data included in the application state information 604 may depend on the type of information associated with the application state and the functionality specified by the application access mechanism 212a. The application state information 604 may include a variety of different types of data, such as structured, semi-structured, and/or unstructured data. The application state information 604 may be automatically and/or manually generated based on documents retrieved from the data sources 130. Moreover, the application state information 604 may be updated so that up-to-date search results 440 are provided in response to a search query 332.

In some examples, the application state information 604 includes data that is presented to the user 10 by an application 204 when the application 204 is set in the application state defined by the access mechanism(s) 212. For example, if one of the access mechanism(s) 212 is an application access mechanism 212a, the application state information 604 may include data that describes a state of the native application 210a after the user device 200 has performed the one or more operations indicated in the application access mechanism 212a. For example, if the application state 600 is associated with a shopping application, the application state information 604 may include data that describes products (e.g., names and prices) that are shown when the shopping application is set to the application state defined by the access mechanism(s) 212. As another example, if the application state 600 is associated with a music player application, the application state information 604 may include data that describes a song (e.g., name and artist) that is played when the music player application is set to the application state defined by the access mechanism(s) 212.

The types of data included in the application state information 604 may depend on the type of information associated with the application state and the functionality defined by the access mechanism(s) 212. For example, if the application state 600 is for an application 204 that provides reviews of restaurants, the application state information 604 may include information (e.g., text and numbers) related to a restaurant, such as a category of the restaurant, reviews of the restaurant, and a menu for the restaurant. In this example, the access mechanism(s) 212 may cause the application 204 (e.g., a native application 210a or a web-browser application 210b) to launch and retrieve information relating to the restaurant. As another example, if the application state 600 is for an application 204 that plays music, the application state information 604 may include information relating to a song, such as the name of the song, the artist, lyrics, and listener reviews. In this example, the access mechanism(s) 212 may cause the application 204 to launch and play the song described in the application state information 604.

The search system 300 may generate application state information 604 included in an application state 600 in a variety of different ways. In some examples, the search system 300 retrieves data to be included in the application state information 604 via partnerships with database owners and developers of native applications 210a. For example, the search system 300 may automatically retrieve the data from online databases 130f that include, but are not limited to, data related to movies, television programs, music, and restaurants. In some examples, a human operator manually generates some data included in the application state information 604. The search system 300 may update data included in the application state information 604 over time so that the search system 300 provides up-to-date results 440 to the user 10.

The application ID 606 may be used to identify a native application 210a associated with the application state 600. The application ID 606 may be a string of alphabetic, numeric, and/or symbolic characters (e.g., punctuation marks) that uniquely identifies the associated native application 210a. In some examples, the application ID 606 the native application 210a in human readable form. For example, the application ID 606 may include the name of the application 204 referenced in the access mechanism(s) 212. In some examples, the application ID 606 for a restaurant finder application 204 includes the name of the restaurant finder application.

An application state 600 including an application access mechanism 212 that causes an application 204 to launch into a default state may include application state information 604 describing the native application 210a, instead of any particular application state. For example, the application state information 604 may include the name of the developer of the application 204, the publisher of the application 204, a category 605a (e.g., genre) of the application 204, a description 605b of the application 204 (e.g., a developer's description), and a price of the application 204. The application state information 604 may also include security or privacy data about the application 204, battery usage of the application 204, and bandwidth usage of the application 204. The application state information 604 may also include application statistics. Application statistics may refer to numerical data related to a native application 210a. For example, application statistics may include, but are not limited to, a number of downloads, a download rate (e.g., downloads per month), a number of ratings, and a number of reviews.

FIG. 6B shows an example application state 600 associated with the OPENTABLE® application, developed by OpenTable, Inc. The OPENTABLE® application is a restaurant-reservation application that allows users 10 to search for restaurants and make restaurant reservations. The OPENTABLE® application provides information about restaurants including descriptions of restaurants and user reviews of the restaurants. The example application state 600 of FIG. 3B describes an application state of the OPENTABLE® application in which the OPENTABLE® application accesses information for THE FRENCH LAUNDRY® restaurant.

The example application state 600 includes an application state ID 602 of “OPENTABLE—THE FRENCH LAUNDRY,” which may be used as a unique identifier to identify the application state 600. In other examples, the application state ID 602 includes a URL as a unique identifier for the application state 600. For example, the application state ID 602 may include the string “http://www.opentable.com/the-french-laundry” as a unique identifier for the application state 600. As described herein, such an application state ID 602 may be included in a web access mechanism 212b of an application state 600. As another example, the application state ID 602 may have a different namespace than “http://,” such as “func://.” In yet another example, the application state ID 602 could be a string of characters, numbers, and/or symbols that are not in human readable form. Each example is optional and may be combined with other examples.

The example application state information 604 includes data fields 605, such as a category 605a of THE FRENCH LAUNDRY® restaurant, a description 605b of THE FRENCH LAUNDRY® restaurant, user reviews 605c of THE FRENCH LAUNDRY® restaurant, and additional data fields 605. The restaurant category 605a field may include the text “French cuisine” and “contemporary,” for example. The description field 605b may include text that describes THE FRENCH LAUNDRY® restaurant. The user reviews field 605c may include text of user reviews for THE FRENCH LAUNDRY® restaurant. The additional data fields 605 may include additional data for THE FRENCH LAUNDRY® restaurant that may not specifically fit within the other defined fields, such as a menu for the restaurant, prices, and operating hours for the restaurant.

The application state 600 includes one or more access mechanism(s) 212. The access mechanism(s) 212 may include a reference to the OPENTABLE® application 204. An example application access mechanism 212a for the application state 600 may include a reference to the OPENTABLE® native application 210a along with one or more operations to be performed by the user device 200. For example, the application access mechanism 212a may include an application resource identifier and/or one or more operations that cause the user device 200 to access the entry for THE FRENCH LAUNDRY® restaurant in the OPENTABLE® native application. An example application resource identifier may be “vnd.opentable.deeplink://opentable.com/restaurant/profile?rid=1180&refid=1.”

In some implementations, an application state 600 includes multiple different application access mechanisms 212, 212a, 212b, 212c that include a variety of information. The application access mechanism 212 may include edition information that indicates the application edition with which the application access mechanism 212 is compatible. For example, the edition information indicates the operating system 216 with which the application access mechanism 212 is compatible. Moreover, different application access mechanisms 212 may be associated with different editions of a native application 210a. A native application edition (hereinafter “application edition”) refers to a particular implementation or variation of a native application 210a. For example, an application edition may refer to a version of a native application 210a, such as a version 1.0 of a native application 210a or a version 2.0 of a native application 210a. In another example, an application edition may refer to an implementation of a native application 210a for a specific platform, such as a specific operating system 216.

The different application access mechanisms 212 included in an application state 600 may cause the corresponding application editions to launch and perform similar functions. Accordingly, the different application access mechanisms 212 included in an application state 600 may cause the corresponding application editions to be set into similar application states. For example, if the different application access mechanisms 212 reference different editions of an information retrieval application, the different application access mechanisms 212 may cause the corresponding application editions to retrieve similar information. In another example, if the different application access mechanisms 212 reference different editions of an internet music player application, the different application access mechanisms 212 may cause the corresponding application editions to play the same song.

In some examples, an application state 600 for a native application that retrieves restaurant information includes multiple different application access mechanisms 212 for multiple different application editions. Assuming the application state record 600 is associated with a specific Mexican restaurant, the application access mechanisms 212 for the different application editions may cause each application edition to retrieve information for the same specific Mexican restaurant. For example, a first application access mechanism 212 may cause a first application edition (e.g., on a first operating system) to retrieve information for the specific Mexican restaurant. A second application access mechanism 212 may cause a second application edition (e.g., on a second operating system) to retrieve information for the specific Mexican restaurant. In some examples, the search system 300 can determine whether to transmit the application access mechanism 212 in the search results 440 based on whether the user device 200 is configured to receive the application access mechanism 212.

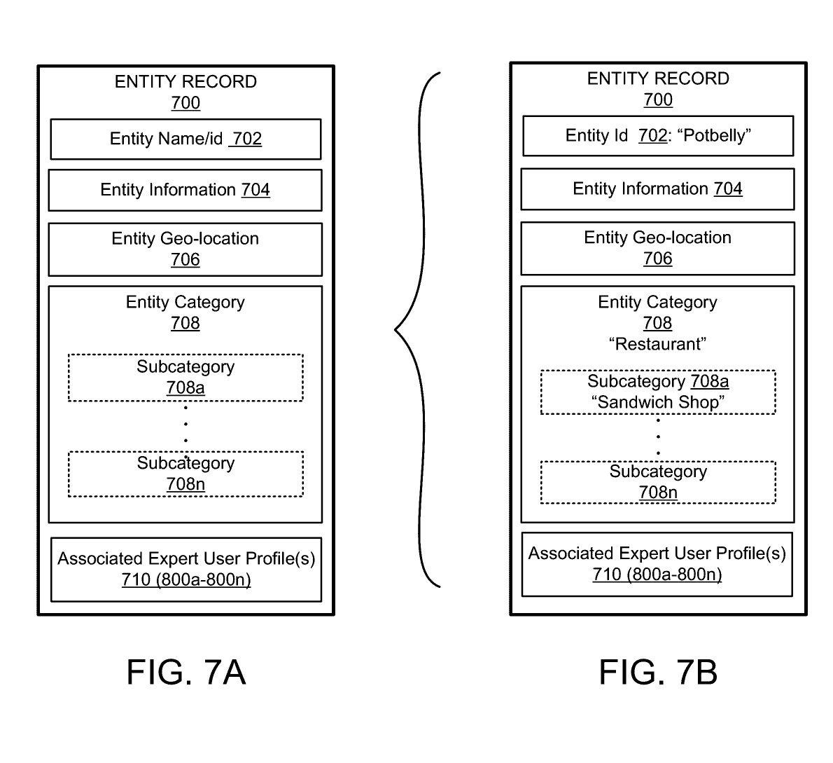

Referring to FIGS. 7A and 7B, the entity review data store 520 includes a plurality of entity records 700. Each entity record 700 may include data related to an entity 540. The entity 540 can be a business or place with a geolocation or person or event (e.g., restaurants, bars, gas stations, supermarkets, movie theaters, doctor offices, sports team, movie star, celebrity, politician, parks, and libraries, etc.). An entity record 700 may include an entity identifier or name (ID) 702, entity location data 706 (e.g., geolocation data), an entity category 708 (and optionally one or more sub-categories 708a-708n), and/or entity information 704.

The entity ID 702 may be used to identify the entity record 700 among the other entity records 700 included in the entity data store 520. The entity ID 702 may be a string of alphabetic, numeric, and/or symbolic characters (e.g., punctuation marks) that uniquely identifies the associated entity record 700. In some examples, the entity ID 702 describes the entity in human readable form. For example, the entity ID 702 may include the name string of the entity or a human readable identifying the entity. In some examples, the entity ID 702 includes a unique number that identifies the entity 540.

In a more specific example, if the entity record 700 describes a restaurant named POTBELLY®, the entity ID 702 for the entity record 700 can be “Potbelly.” In an example where the entity ID 702 includes a string in human readable form and/or a URL, the entity ID 702 may include the following string “Potbelly” to uniquely identify the entity record 700. Other unique identifiers are possible as well, such as store number.

The entity information 704 may include any information about the entity, such as text (e.g., description, reviews) and numbers (e.g., number of reviews). This information may even be redundant to other information contained in the entity record 700, but optionally structured for display, for example. The entity information 704 may include a variety of different types of data, such as structured, semi-structured, and/or unstructured data. Moreover, the entity information 704 may be automatically and/or manually generated based on documents retrieved from the data sources 130.

The entity location data 706 may include data that describes a location of the entity. This data may include a geolocation (e.g., latitude and longitude coordinates), a street address, or any information that can be used to identify the location of the entity 540. In some implementations, the entity location data 706 defines a geo-location associated with the application state record 600.

The entity category 708 provides a classification or grouping of the entity 540. Moreover, the entity category 708 can have one or more sub-categories 708a to further classify the entity 540. For example, the entity record 700 could have an entity category 708 of “restaurant” and a sub-category 708a of a type of cuisine, such as “Sandwich Shop,” “French cuisine.” or “contemporary.” Any number of sub-categories 708a-708n may be assigned to classify the entity 540 for use during a search.

The entity record 700 includes associated expert user profiles 710 that include a list of all the user profiles 800 that are experts with respect to the entity 540 associated with the entity record 700. Therefore, when the system 100 identifies entities 540 associated with a search result 440, the system 100 looks up the entity record 700 of the identified entity 540 to determine the experts within the field of that entity 540.

FIG. 8 shows a user profile record 800 generated by the expertise system 500. The user profile record 800 includes a user name/ID 802 that identifies a user 10 associated with the user profile record 800. The user profile record 800 includes information 804 relating to the user 10, e.g., age, gender, education, or any other information related information. In some examples, the user profile record 800 includes a user geo-location 806 that identifies a location of the user 10, e.g., country, city, address.

Each user profile record 800 includes the review records 808a-808n associated with the user profile 800. Each review record 808 includes a review title/name/ID 810, an application name/ID identifying the application or website that the user 10 to write the review record 808. A text field 812 includes the verbiage of the review record 808 as the user 10 submitted the review via the identified application 812. A rating 816 is also included in each review record 808 and indicates how close the user's review is to the average reviewers (i.e., to others reviewing the same object 550). Helpfulness 818 includes information pertaining to whether other users 10 found the review record 808a helpful. Skill level 820 includes information relating to the skill level of the user 10. In some examples, an application or a website rates the skill level of user posting reviews based on several factors. For example, a user 10 may be a critic, an intermediate user 10, or other rankings provided by the application or website. As shown, each review record 808 is associated with a list of entities 540 retrieved from the entity data store 520.

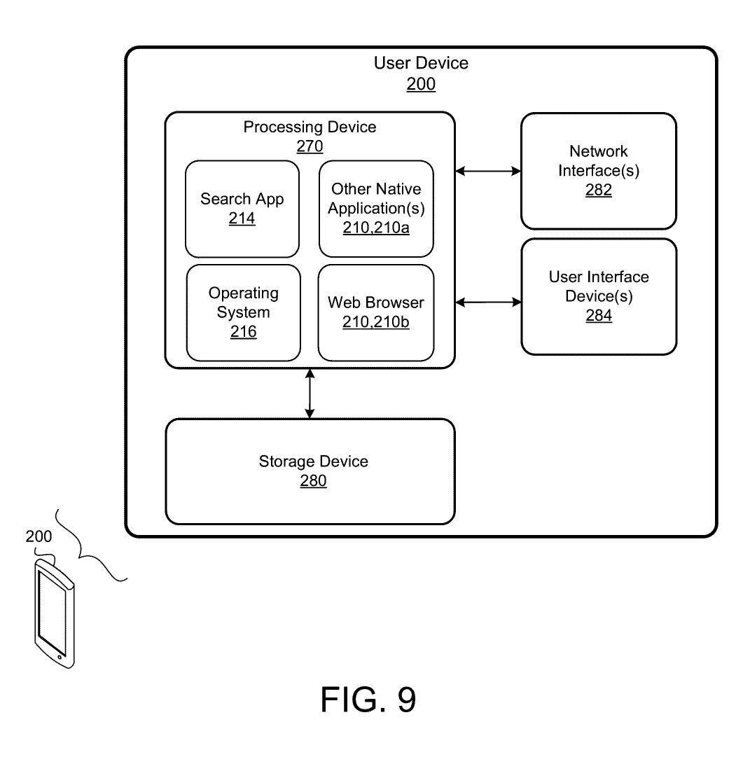

FIG. 9 illustrates an example user device 200 including data processing hardware 270 in communication with memory hardware 280, a network interface device 282, and a user interface device 284 (e.g. screen). The user device 200 may include other components as well. The data processing hardware 270 is configured to execute instructions stored on the memory hardware 280 that when executed on the data processing hardware 270 cause the data processing hardware 270 to perform operations. In some examples, the data processing hardware 270 executes one or more of a native application 210a, a web browser 210b, and an operating system 216, all of which may be embodied as computer readable instructions. The operating system 216 may act as an interface between the data processing hardware 270 and the applications 210.

In some implementations, the data processing hardware 270 executes a search application 214. The search application 214 is a set of computer readable instructions embedded in a native application 210a, i.e., the search application 214. The memory hardware 280 may be physical devices used to store programs (e.g., sequences of instructions) or data (e.g., program state information) on a temporary or permanent basis as non-transitory memory for use by a computing device. For example, the memory hardware 280 may store the computer readable instructions that make up the native applications 210a, the web browser 210b, the operating system 216, and/or the search application 214. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), and phase change memory (PCM). The network interface device 282 includes one or more devices configured to communicate with the network 120.

The network interface 282 can include one or more transceivers for performing wired or wireless communication. Examples of the network interface 282 include, but are not limited to, a transceiver configured to perform communications using the IEEE 802.11 wireless standard, an Ethernet port, a wireless transmitter, and a universal serial bus (USB) port. The user interface 284 includes one or more devices that receive input from and/or provide output to a user 10. The user interface 284 can include, but is not limited to, a touchscreen, a display, a QWERTY keyboard, a numeric keypad, a touchpad, a microphone, and/or speakers.

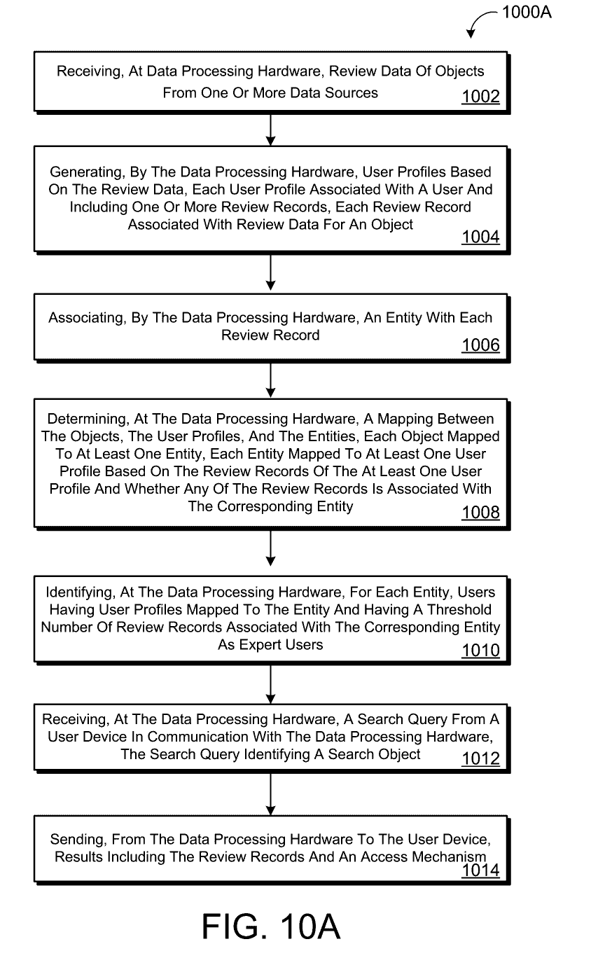

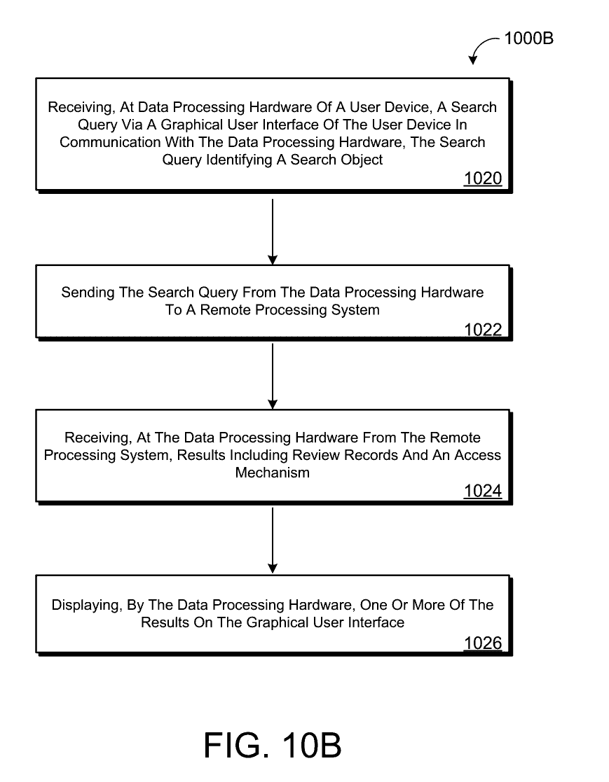

FIG. 10A provides an example arrangement of operations for a method 1000A of determining expert reviewers and sending a user device 200 expert reviews associated with the expert reviewers. The method 1000A is described with respect to the user device 200 and the state rendering system 400 and an expertise system 500 as illustrated in FIGS. 1-9.

At block 1002, the method 1000A includes receiving, at data processing hardware (e.g., a search system 300, a state rendering system 400 and/or an expertise system 500) review data (e.g., review records 808) of objects 550 from one or more data sources 130. At block 1004, the method 1000A includes generating, by the data processing hardware, user profiles 800 based on the review data. Each user profile 800 is associated with a user 10 and includes one or more review records 808. Each review record 808 is associated with review data for an object 550. At block 1006, the method 1000A further includes associating, by the data processing hardware, an entity 540 with each review record 808. At block 1008, the method 1000A includes determining, at the data processing hardware, a mapping between the objects 550, the user profiles 800, and the entities 540. Each object 550 is mapped to at least one entity 540, and each entity 540 is mapped to at least one user profile 800 based on the review records 808 of the at least one user profile 800 and whether any of the review records 808 is associated with the corresponding entity 540. At block 1010, the method 1000A further includes identifying, at the data processing hardware, for each entity 540, users 10 having user profiles 800 mapped to the entity 540 and having a threshold number of review records 808 associated with the corresponding entity 540 as expert users. At block 1012, the method 1000A includes receiving, at the data processing hardware, a search query 332 from a user device 200 in communication with the data processing hardware. The search query 332 identifies a search object. At block 1014, the method 1000A also includes sending, from the data processing hardware to the user device 200, results including: the review records 808 from the user profiles 800 of the expert users mapped to the search object; and an access mechanism 212 for each review record 808. Each access mechanism 212 has a reference to a corresponding application 210 executable on the user device 200 and indicates a performable operation for the corresponding application 210 to enter an operating state providing information from the corresponding review record 808.

In some implementations, the object 550 includes a physical item, an entity 540, a place, or an experience. The entity 540 may include at least one of a business type, an object type, a cuisine, a location, or a food type. Each review record 808 may include at least one of a review name, an application 210 or a website associated with the review, text string, a rating, helpfulness information, or skill level information.

In some implementations, the method 1000A includes, after receiving the search query 332, identifying a corresponding entity 540 associated with the search object; and determining, by the data processing hardware, one or more expert users mapped to the corresponding entity 540. Each profile record 800 may include a user name or identifier, a geo-location associated with the user device 200, and the review records 808 associated with corresponding entities 540.

FIG. 10B provides an example arrangement of operations for a method 1000B of determining expert reviewers and sending a user device 200 expert reviews associated with the expert reviewers. The method 1000B is described with respect to the user device 200 and the state rendering system 400 and an expertise system 500 as illustrated in FIGS. 1-9.

At block 1020, the method 1000B includes receiving, at data processing hardware 270 of a user device 200, a search query 332 via a graphical user interface of the user device 200 in communication with the data processing hardware 270. The search query 332 identifies a search object 550. At block 1022, the method 1000B includes sending the search query 332 from the data processing hardware 270 to a remote processing system. At block 1024, the method 1000B further includes receiving, at the data processing hardware 270 from the remote processing system, results including review records 808 from user profiles 800 of expert users mapped to the search object 550. The user profiles 800 are based on review data received at the remote processing system. Each user profile 800 is associated with a user 10 and includes one or more review records 808. Each review record 808 is associated with review data associated with the search object 550 and an entity 540. The user profiles 800 of the expert users include users 10 having user profiles 800 mapped to the entity 540 associated with the search object 550 and having a threshold number of review records 808 associated with the corresponding entity 540. The method 1000B further includes an access mechanism 212 for each review record 808, each access mechanism 212 having a reference to a corresponding application 210 executable on the data processing hardware 270 and indicating a performable operation for the corresponding application 210 to enter an operating state providing information from the corresponding review record 808. At block 1026, the method 1000B further includes displaying, by the data processing hardware 270, one or more of the results on the graphical user interface.

The object 550 may include a physical item, an entity 540, a place, or an experience. The entity 540 includes at least one of a business type, an object type, a cuisine, a location, or a food type. Each review record 808 may include at least one of a review name, an application 210 or a website associated with the review, text string, a rating, helpfulness information, or skill level information. Each profile record 800 may include a user name or identifier, a geo-location associated with the user device 200, and the review records 808 associated with corresponding entities 540.

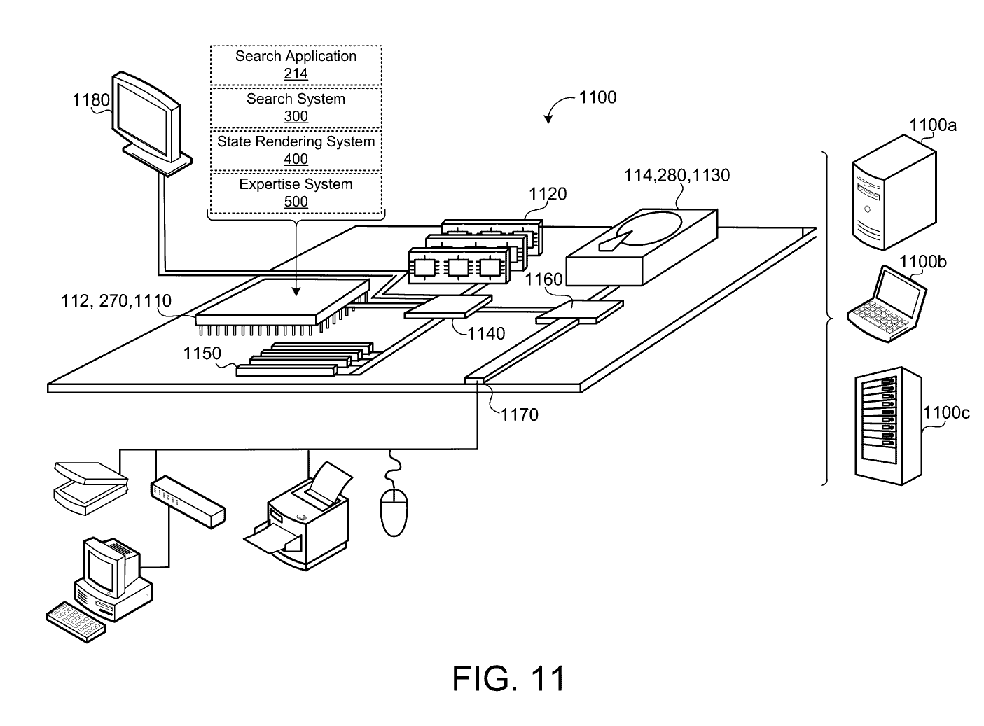

FIG. 11 is schematic view of an example computing device 110 that may be used to implement the systems and methods described in this document. The computing device 1100 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the disclosure described and/or claimed in this document.

The computing device 1100 includes a processor 112, 270, 1110, memory 1120, a storage device 114, 280, 1130, a high-speed interface/controller 1140 connecting to the memory 1120 and high-speed expansion ports 1150, and a low speed interface/controller 1160 connecting to low speed bus 1170 and storage device 1130. Each of the components 1110, 1120, 1130, 1140, 1150, and 1160, are interconnected using various busses, and may be mounted on a common motherboard or in other manners as appropriate. The processor 1110 can process instructions for execution within the computing device 1100, including instructions stored in the memory 1120 or on the storage device 1130 to display graphical information for a graphical user interface (GUI) on an external input/output device, such as display 1180 coupled to high speed interface 1140. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1120 stores information non-transitorily within the computing device 1100. The memory 1120 may be a computer-readable medium, a volatile memory unit(s), or non-volatile memory unit(s). The non-transitory memory 1120 may be physical devices used to store programs (e.g., sequences of instructions) or data (e.g., program state information) on a temporary or permanent basis for use by the computing device 1100. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1130 is capable of providing mass storage for the computing device 1100. In some implementations, the storage device 1130 is a computer-readable medium. In various different implementations, the storage device 1130 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1120, the storage device 1130, or memory on processor 1110.

The high speed controller 1140 manages bandwidth-intensive operations for the computing device 1100, while the low speed controller 1160 manages lower bandwidth-intensive operations. Such allocation of duties is exemplary only. In some implementations, the high-speed controller 1140 is coupled to the memory 1120, the display 1180 (e.g., through a graphics processor or accelerator), and to the high-speed expansion ports 1150, which may accept various expansion cards (not shown). In some implementations, the low-speed controller 1160 is coupled to the storage device 1130 and low-speed expansion port 1170. The low-speed expansion port 1170, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 1100 may be implemented in a number of different forms, as shown in the figure. For example, it may be implemented as a standard server 1100a or multiple times in a group of such servers 1100a, as a laptop computer 1100b, or as part of a rack server system 1100c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at data processing hardware, review data of objects from one or more data sources;
generating, by the data processing hardware, user profiles based on the review data, each user profile associated with a user and comprising one or more review records, each review record associated with review data for an object;
associating, by the data processing hardware, an entity with each review record;
determining, at the data processing hardware, a mapping between the objects, the user profiles, and the entities, each object mapped to at least one entity, each entity mapped to at least one user profile based on the review records of the at least one user profile and whether any of the review records is associated with the corresponding entity;
identifying, at the data processing hardware, for each entity, users having user profiles mapped to the entity and having a threshold number of review records associated with the corresponding entity as expert users;
receiving, at the data processing hardware, a search query from a user device in communication with the data processing hardware, the search query identifying a search object; and
sending, from the data processing hardware to the user device, results comprising:
the review records from the user profiles of the expert users mapped to the search object; and
an access mechanism for each review record, each access mechanism having a reference to a corresponding application executable on the user device and indicating a performable operation for the corresponding application to enter an operating state providing information from the corresponding review record.

2. The method of claim 1, wherein the object comprises a physical item, an entity, a place, or an experience.

3. The method of claim 1, wherein the entity comprises at least one of a business type, an object type, a cuisine, a location, or a food type.

4. The method of claim 1, wherein each review record comprises at least one of a review name, an application or a website associated with the review, text string, a rating, helpfulness information, or skill level information.

5. The method of claim 1, further comprising:
after receiving the search query, identifying a corresponding entity associated with the search object; and
determining, by the data processing hardware, one or more expert users mapped to the corresponding entity.

6. The method of claim 1, wherein each profile record comprises a user name or identifier, a geo-location associated with the user device, and the review records associated with corresponding entities.

7. A method comprising:
receiving, at data processing hardware of a user device, a search query via a graphical user interface of the user device in communication with the data processing hardware, the search query identifying a search object;
sending the search query from the data processing hardware to a remote processing system;
receiving, at the data processing hardware from the remote processing system, results comprising:
review records from user profiles of expert users mapped to the search object, the user profiles based on review data received at the remote processing system, each user profile associated with a user and comprising one or more review records, each review record associated with review data associated with the search object and an entity, the user profiles of the expert users comprising users having user profiles mapped to the entity associated with the search object and having a threshold number of review records associated with the corresponding entity; and
an access mechanism for each review record, each access mechanism having a reference to a corresponding application executable on the data processing hardware and indicating a performable operation for the corresponding application to enter an operating state providing information from the corresponding review record; and
displaying, by the data processing hardware, one or more of the results on the graphical user interface.

8. The method of claim 7, wherein the object comprises a physical item, an entity, a place, or an experience.

9. The method of claim 7, wherein the entity comprises at least one of a business type, an object type, a cuisine, a location, or a food type.

10. The method of claim 7, wherein each review record comprises at least one of a review name, an application or a website associated with the review, text string, a rating, helpfulness information, or skill level information.

12. The method of claim 7, wherein each profile record comprises a user name or identifier, a geo-location associated with the user device, and the review records associated with corresponding entities.

13. A user device comprising:
data processing hardware;
a screen in communication with the data processing hardware; and
memory hardware in communication with the data processing hardware, the memory hardware storing instructions that when executed on the data processing hardware cause the data processing hardware to perform operations comprising:
receiving a search query via a graphical user interface displayed on a graphical user interface on the screen, the search query identifying a search object;
sending the search query from the data processing hardware to a remote processing system;
receiving, at the data processing hardware from the remote processing system, results comprising:
review records from user profiles of expert users mapped to the search object, the user profiles based on review data received at the remote processing system, each user profile associated with a user and comprising one or more review records, each review record associated with review data associated with the search object and an entity, the user profiles of the expert users comprising users having user profiles mapped to the entity associated with the search object and having a threshold number of review records associated with the corresponding entity; and
an access mechanism for each review record, each access mechanism having a reference to a corresponding application executable on the data processing hardware and indicating a performable operation for the corresponding application to enter an operating state providing information from the corresponding review record; and
displaying one or more of the results on the graphical user interface.

14. The user device of claim 13, wherein the search object comprises a physical item, an entity, a place, or an experience.

15. The user device of claim 13, wherein the entity comprises at least one of a business type, an object type, a cuisine, a location, or a food type.

16. The user device of claim 13, wherein each review record comprises at least one of a review name, an application or a website associated with the review, text string, a rating, helpfulness information, or skill level information.

17. The user device of claim 13, wherein each profile record comprises a user name or identifier, a geo-location associated with the user device, and the review records associated with corresponding entities.
